(19) United States
(12) Patent Application Publication
(10) Pub. No.: US 2016/0341593 A1
(43) Pub. Date: Nov. 24, 2016

(54) METHODS AND APPARATUS TO DETECT COMPOUND METER FAILURE

(71) Applicant: Itron, France, Issy-les-Moulineaux (FR)

(72) Inventors: Christophe Schweitzer, SCHWENHEIM (FR); Thibaut Lebreton, MACON (FR); Florian Barletta, MACON (FR)

(21) Appl. No.: 14/720,202

(22) Filed: May 22, 2015

(51) Int. Cl. G01F 25/00; G01F 7/00

(52) U.S. Cl. CPC G01F 25/0007; G01F 7/00

(57) ABSTRACT

Methods and apparatus to determine compound meter failure are disclosed. One disclosed example apparatus includes a receiver to receive fluid flow rate data from a first fluid flow rate meter on a first channel of a compound utility meter and a second fluid flow rate meter on a second channel of the compound utility meter. The example apparatus also includes a processor communicatively coupled to the receiver, where the processor is to determine a failure condition of the compound utility meter based on the flow rate data received from the first and second fluid flow rate meters.

### FIELD OF THE DISCLOSURE

This disclosure relates generally to compound meters and, more particularly, to methods and apparatus to detect compound meter failure.

### BACKGROUND

Compound meters (e.g., compound water meters, compound utility meters) are often used in, for example, commercial or home water utility systems to measure an amount of water provided and/or consumed in a building and/or an area. Compound utility meters often utilize multiple flow meters to more accurately measure a fluid at different flow rates due to limited accuracy ranges characteristic of flow meters. To accurately measure flow rates at different flow ranges, compound utility meters usually have a high flow rate flow meter on a high flow rate portion, or branch, of the utility meter and a low flow rate flow meter on a low flow rate portion, or branch, of the utility meter. Compound utility meters also typically include a bypass mechanism (e.g., a bypass valve, a commutation valve, a pressure valve, etc.) to divert and/or switch flow between either a high flow rate branch or a low flow rate branch so flow rates can be accurately measured at different flow rate regimes/ranges.

It is sometimes difficult to determine whether a compound utility meter has failed until the resulting effects are severe (e.g., an outage, incorrect billing over a significant time duration, etc.). Incorrect compound flow meter measurements are often discovered at a significant time (days, weeks, etc.) after the compound utility meter has failed. For example, when a low flow rate flow is prevented from bypassing a high flow rate branch, the low flow rate flow may instead flow through the high flow rate branch, which may result in inaccurate measurements of the flow rate, thereby causing a billing issue (e.g., underbilling) and/or potential dissatisfaction of utility customers due to overbilling. In other situations, a failure that prevents flow into a high flow rate branch of a compound utility meter may cause a reduced flow rate through a low flow rate branch (e.g., a low flow rate even during a time period with high flow rate demands), which can sometimes result from a small cross-sectional diameter of the low flow rate branch. Such restricted flow can often result in outages. Because compound utility meters may often fail unpredictably, they are often replaced based on a defined duration of time in the field (e.g., three years, several months, etc.), regardless of usage and/or condition of the compound utility meters, thereby resulting in higher replacement and/or part costs, even if the compound utility meters are operating normally. Compound utility meters are often tested on test benches, however, such test benches often require removal of the meter, testing the meter, repair if necessary, and reinstalling the meter. This process may be costly in terms of labor, testing time, and downtime.

### BRIEF DESCRIPTION OF THE DRAWINGS

FIG. 1 is a schematic illustration of an example system in accordance with the teachings of this disclosure.

FIG. 2 is an example compound utility meter that may be used to implement the examples disclosed herein.

FIG. 3 is a cross-sectional view of the example compound utility meter of FIG. 2.

FIGS. 4A and 4B illustrate operating scenarios of the example compound utility meter of FIG. 2

FIGS. 5A and 5B illustrate operating scenarios of an example utility meter with a commutation valve.

FIG. 6 is an example flow meter range graph that illustrates example flow meter operations and use of the examples disclosed herein.

FIG. 7A is a screenshot of an example interface that may accept input utility meter parameters.

FIG. 7B is a screen shot of another example interface that may accept input utility meter parameters.

FIG. 8 depicts an example output display that may be used to indicate potential failures of multiple compound utility meters based on the examples disclosed herein.

FIG. 9 is an example system to implement the examples disclosed herein.

FIG. 10 is a flow chart representative of an example process, which may be implemented using machine readable instructions, to implement the examples disclosed herein.

FIG. 11 is a block diagram of an example processor platform capable of executing machine readable instructions to implement the processes of FIG. 10.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this disclosure, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to detect compound meter are disclosed herein. Compound utility meters (e.g., compound meters, compound water meters, bypass water meters, etc.) are typically used to measure flow rates of water provided to residential and/or commercial areas or buildings. These compound utility meters typically use multiple flow meters to accurately measure flow consumption at different flow ranges and/or pressures (e.g., different flow regimes). In particular, compound utility meters usually have a high flow rate branch with a high flow rate meter and a low flow rate branch with a low flow rate meter. Typically, the high flow rate branch is bypassed and/or isolated in low flow rate conditions and the low flow rate branch is not bypassed in a high flow rate condition because a low cross-sectional diameter of the low flow rate branch still maintains a relatively low flow rate therethrough while the high flow rate branch accommodates the increased pressure of the high flow rate condition, for example. Alternatively, in some examples, the low flow rate branch is bypassed in high flow rate conditions.

Typically, failure of the compound utility meters may involve prevention of flow from entering into the high flow rate branch (e.g., a valve failure only allows flow through the low flow rate branch). This prevention of flow into the high flow rate branch may result in lower output than needed (e.g., demand significantly surpasses available supplied flow via the low flow rate branch). Scenarios in which the high flow branch is prevented from being bypassed result in lower flow rates through the high flow branch that may cause inaccurate flow measurements (e.g., too low or unmeasured flow) at the high low rate meter, thereby causing potential billing errors, loss revenue and/or utility customer dissatisfaction.

The examples disclosed herein allow for efficient real-time monitoring of compound utility meters (e.g., compound utility meters that are installed, on-site and/or commissioned, compound utility meters in an operational state, compound meters in which fluid flows therethrough), thereby reducing operating costs for utilities that are typically associated with premature scheduled replacement of the compound utility meters. The examples disclosed herein minimize and/or eliminate expenses associated with typical testing of compound utility meters in the field in which compound utility meters are tested on test benches. Such typical bench testing often requires removal of the meter, testing the meter, repair if necessary, and reinstalling the meter, which can be costly in terms of labor, testing time, and downtime. The examples disclosed herein receive flow rate data from first and second channels (e.g., high and low flow rate branches) of a compound utility meter and determine a failure condition of the compound utility meter based on the flow rate data. This determination of the failure condition (e.g., whether the compound utility meter is operating normally or has failed) also enables quick replacement of compound utility meters that have failed in the field.

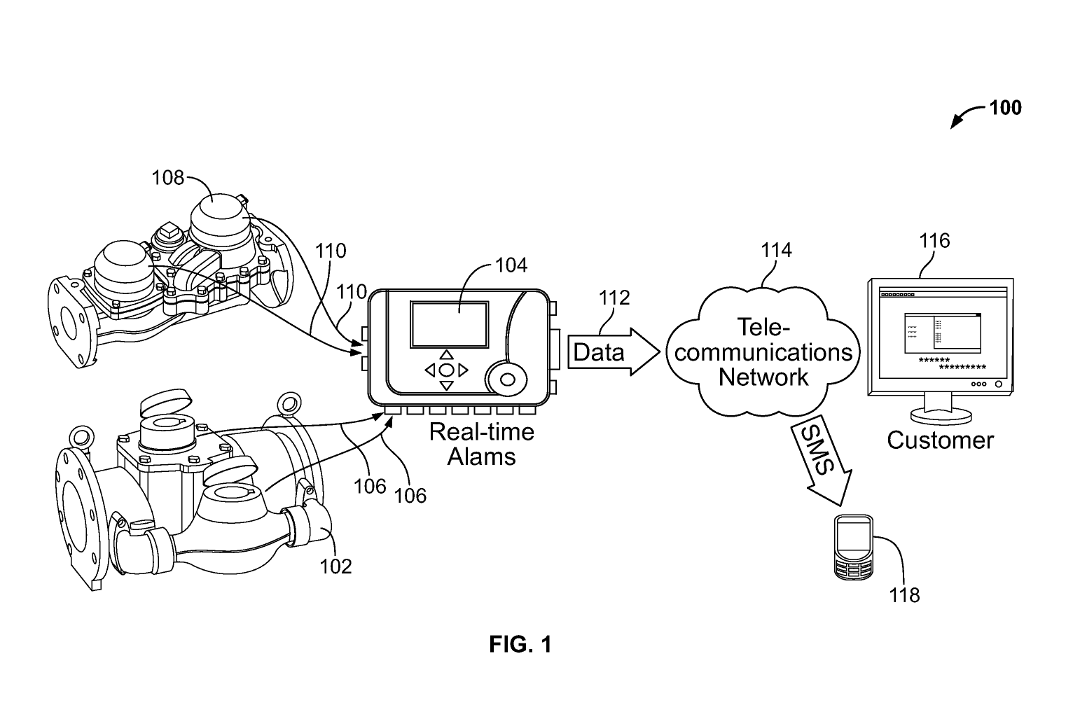

FIG. 1 is a schematic illustration of an example compound utility meter monitoring system 100 in accordance with the teachings of this disclosure. The monitoring system 100 of the illustrated example includes a first compound utility meter 102, which is installed in the field, a data analyzer (e.g., data receiver/analyzer) 104, communication lines 106 that communicatively couple the compound utility meter 102 to the data analyzer 104, a second compound utility meter 108, which is also installed in the field, communication lines 110 that communicatively couple the compound utility meter 108 to the data analyzer 104. In this example, the data analyzer 104 transfers data (e.g., flow rate data, flow rate history, flow rate threshold comparisons, etc.) 112 to a telecommunications network (e.g., a data collection network) 114, which may be in communication with (e.g., in wireless communication with, etc.) a customer terminal 116 and/or a portable device (e.g., a mobile phone, a tablet, etc.) 118.

The first and second compound utility meters 102, 108 of the illustrated example are installed water utility meters for use in residential, commercial sites and/or buildings, for example. The first and second compound utility meters 102, 108 may be used to determine flow rates through respected utility water pipes connected thereto and, thus, may be used for billing determinations and/or to measure water consumption. In this example, the compound utility meters 102, 108 operate in a similar fashion (e.g., both have fluid pressure based bypass mechanisms), but are adapted for different flow rates and/or uses. The data analyzer 104 of the illustrated example may be located near the compound utility meters 102, 108 and is used to monitor and/or receive water consumption data from the compound utility meters 102, 108.

The data analyzer 104 of the illustrated example transfers the data 112 to the communication network 114, which may be a data network used by a utility company, for example, to monitor operations of multiple utility meters of different systems, etc. The example customer terminal 116 may be a part of a utility company monitoring system (e.g., the company is the customer) or part of a monitoring system for an individual (e.g., a residential customer) or business, for example. In some examples, the portable device 118 may correspond to a portable device carried by service personnel of a utility company and/or a service provider for the utility company.

In operation, the data analyzer 104 receives flow measurements and/or alarms (e.g., alarms indicating one or more flow rates that are out of threshold ranges, etc.). In particular, the data analyzer 104 of the illustrated example receives (e.g., simultaneously receives, periodically receives, conditionally receives, polls) flow measurement data from multiple flow branches of the first compound utility meter 102 and the second compound utility meter 108 via the communication lines 106, 110, respectively. In this example, the data analyzer 104 monitors the incoming data (e.g., flow rate data, differential flow rate data, flow data history, etc.) from the first and second compound utility meters 102, 108.

For example, the data analyzer 104 monitors and/or records flow rate information (e.g., flow rate data) from the first and second compound utility meters 102, 108, which may include whether high and/or low flow rate branches of the aforementioned flow branches are or have been operating out of respective threshold ranges (e.g., at an instant or moment, for a significant time, as demonstrated by time-history and/or a time in which each of the high and low flow rate branches measures flow, etc.) from both the high flow rate and low flow rate branches of the compound utility meters 102, 108. In this example, the data analyzer 104 transmits and/or indicates an alarm when the flow rate information of one or more of the flow rate branches is out of an acceptable range/threshold (e.g., out of an acceptable range/threshold, out of an acceptable range/threshold for a pre-defined time duration, etc.). In particular, the data analyzer 104 may transmit an alarm indication in the data 112 to the telecommunications network 114 when one or more of the flow rate branches have flow rates that are beyond respective thresholds.

In turn, the telecommunications network 114 of the illustrated example may transmit the alarm and/or indicate a presence of an alarm at the terminal 116 and/or the portable device 118. In another example, the data analyzer 104 may convey the flow rate information to the terminal 116 via the telecommunications network 114 and the terminal 116 may be used to analyze the flow rate information and/or generate alarms or alerts.

The compound meters 102, 108 each have multiple flow branches (e.g., the high and low flow rate branches). Accordingly, the data analyzer 104 may monitor whether flow rates are within their respective thresholds, perform comparative measurements of the multiple flow branches (e.g., flow rate measurements and/or analyze a flow rate measurement history related to high and low flow branches of a compound meter) to determine a failure condition(s) (e.g., an operating condition, a failure/operational status, a failure status) of one or more of the compound meters 102, 108. Additionally or alternatively, the data analyzer 104 may perform time-study analysis of flow rate data through multiple flow branches of compound utility meters. The failure condition of each of the compound meters 102, 108 may, thus, in some examples, be based on a relationship of flow rate measurements between the high and low flow rate branches of the respective compound meters 102, 108.

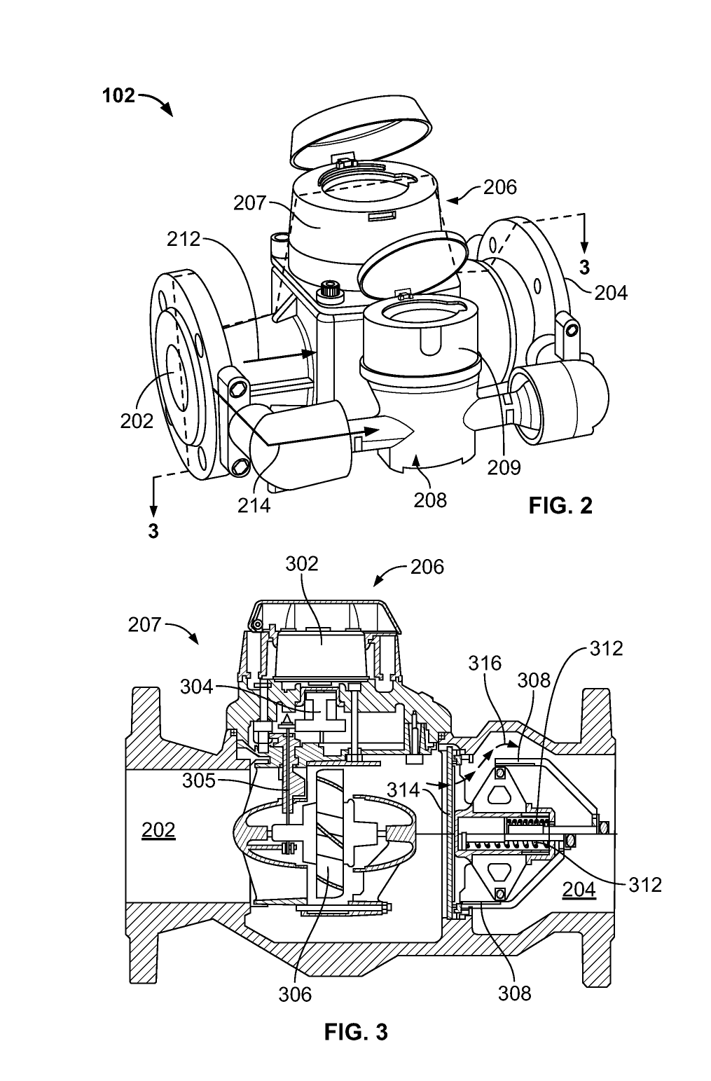

FIG. 2 illustrates the example utility compound meter 102 of FIG. 1 that may be used to implement the examples disclosed herein. The example compound meter 102 includes an inlet 202 and an outlet 204, both of which are fluidly coupled to a high flow rate portion (e.g., a high flow rate branch) 206 with a corresponding high flow rate meter 207. The inlet 202 and the outlet 204 are also fluidly coupled to a low flow rate portion (e.g., a low flow rate branch) 208 with a corresponding low flow rate meter 209. Both of the portions 206, 208 allow an inlet flow to be directed into one of the portions 206, 208 or simultaneously through both of the portions 206, 208 as parallel flows (e.g., parallel flow branches). In this example, a first flow (e.g., a high flow rate flow, a high pressure flow) flows in a direction generally indicated by an arrow 212 through the high flow rate portion 206. Likewise, in parallel, a second flow (e.g., a low flow rate flow, a low pressure flow) flows in a direction generally indicated by an arrow 214. In this example, an inlet flow is generally diverted to either the low flow rate portion 208 (e.g., the high flow rate portion 206 is bypassed) or the high flow rate portion 206, along with the low flow rate portion 208 (e.g., the high flow rate portion 206 is not bypassed) based on a flow rate and/or a pressure at the inlet 202.

In some examples, when the high flow rate portion 206 is not bypassed, the first and second flows that flow in parallel may converge at the outlet 204 before exiting the compound utility meter 102. In parallel flow scenarios in which the high flow rate portion 206 is not bypassed, flow may not be required to be diverted from the low flow portion 208 because its relatively smaller diameter restricts flow rates and, thus, the low flow portion does not need to be bypassed in high flow rate conditions (e.g., flow rates at the high flow rate portion 206 and the low flow rate portion 208 may be summed and/or integrally summed).

FIG. 3 is a cross-sectional view of the high flow rate portion 206, which directs flow between the high and low flow rate portions 206, 208, of the example utility meter 102 of FIG. 1 taken along a line 3-3 of FIG. 2. In the view of FIG. 3, both open and closed positions of the high flow portion 206 are shown. The high flow rate portion 206 of the illustrated example controls whether flow is diverted through or away from the high flow rate portion 206 based on fluid pressure provided at and/or proximate the inlet 202. The example high flow rate portion 206 includes the high flow rate meter 207 with a communications/electronics module 302, which may include a display, measuring/detection hardware and/or communication hardware (e.g., wireless communication hardware, etc.), a sensing transducer 304, a differential (e.g. a coupler) 305 and an impeller 306. The example high flow rate portion 206 also includes a pressure member 308, a spring 312 and a closure plate (e.g., a sealing plate) 314.

The pressure member 308 is simultaneously shown in two different positions in the view of FIG. 3. In particular, the pressure member 308 of the illustrated example has a first position in which the pressure member 308 prevents flow through the high flow rate portion 206 by sealing against a surface, which will be described in greater detail below. The pressure member 308 also has a second position in which the pressure member 308 moves away from the surface to allow fluid to flow through the high flow rate portion 206. Both the first and second positions (e.g., sealing and non-sealing positions), which are mutually exclusive, of the pressure member 308 are shown in FIG. 3 for clarity. Likewise, the spring 312 is shown simultaneously in both the first and second positions of the pressure member 308.

During operation, fluid may enter the high flow rate portion 206 at the inlet 202 and may pass therethrough based on sufficient flow rate and/or pressure (e.g., a pressure above a defined threshold) of the fluid, for example. In particular, if the fluid has enough pressure to surpass a threshold pressure, the fluid may then cause the pressure member 308 to displace towards the outlet 204, thereby causing the pressure member 308 to separate from the closure plate 314 and, thus, allowing a flow 316 to flow from the inlet 202 to the outlet 204 via the high flow rate portion 206. In this example, the pressure acting against the pressure member 308 counteracts a force of the spring 312 to displace the pressure member 308 from the closure plate 314. Conversely, if the fluid entering the inlet 202 does not have a pressure larger than the threshold pressure, the pressure member 308 of the illustrated example does not displace (or minimally displaces) away from the closure plate 314 due to the force provided by the spring 312, thereby significantly preventing flow through the high flow rate portion 206.

If the pressure of the fluid surpasses the threshold pressure, the fluid flows through the high flow rate portion 206 and, thus, the high flow rate meter 207 measures the fluid flowing therethrough. In this example, the flow of the fluid moves past the impeller 306, thereby causing the impeller 306 to rotate due to contours and/or an overall shape of the impeller 306 in combination with the fluid flow. The impeller 306 of the illustrated example then causes the differential 305 to rotate and, in turn, causes the transducer 304 to rotate. In this example, the rotation of the transducer 304 is detected by the communications module 302 as flow. In some examples, the communications module 302 has a Hall Effect sensor to measure changes in a magnetic field from magnets of the sensing transducer 304, thereby allowing determination of a rotational speed of the sensing transducer 304 relative to the communication module 302 and, thus, a calculated flow rate based on the rotation of the impeller 306, for example.

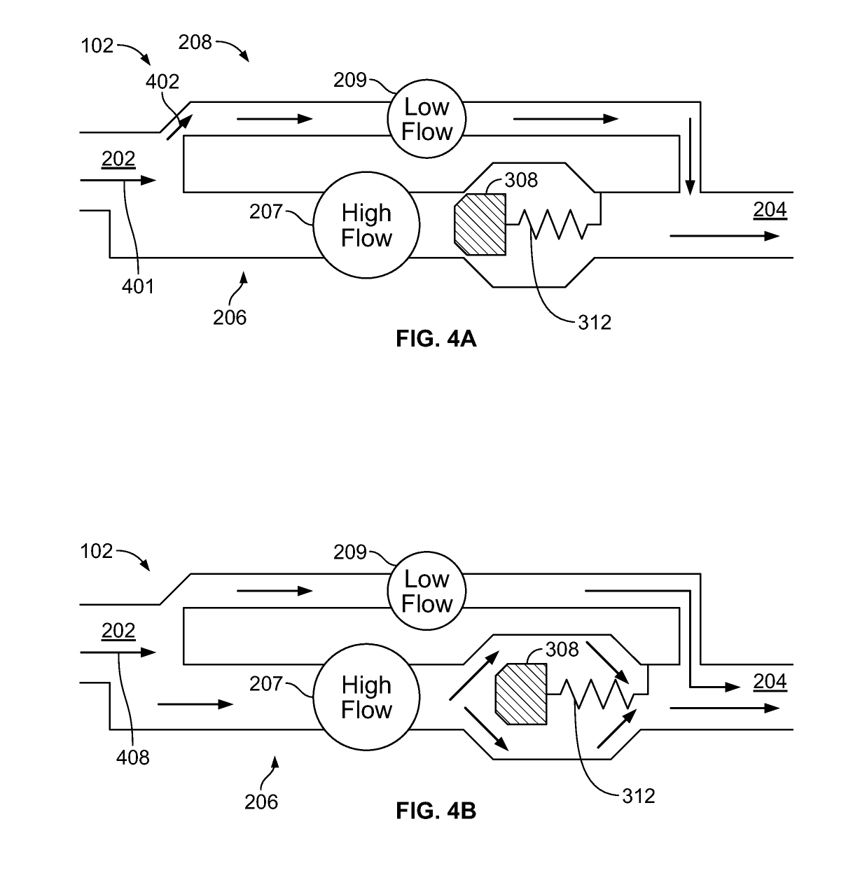

FIGS. 4A and 4B illustrate operating scenarios of the example compound utility meter 102 of FIG. 1 in which the examples disclosed herein may reveal damaged and/or faulty operation of the compound utility meter 102. FIG. 4A illustrates an example scenario in which the pressure member 308 is stuck in a closed position despite sufficient pressure of fluid at the inlet 202 provided from a high flow rate flow 401 and, thus, the high flow rate portion 206 is blocked from fluid flow therethrough. In this example scenario, the high flow rate inlet flow 401 from the inlet 202 to the outlet 204 is restricted to flow in a direction, which is generally indicated by an arrow 402, towards the low flow rate meter 209 and into the outlet 204. In this example, a restricted amount of fluid is allowed to pass through the low flow rate portion 208 and the low flow meter 209, which may be due to a low cross-sectional diameter of the low flow rate portion 208, while flow to the high flow meter 207 is prevented entirely. In other words, diminished fluid supply may be caused by a failure of mechanisms related to the closure member 308 and/or a failure of the closure member itself. In particular, prevention of the pressure member 308 from operating normally (e.g., displacing properly to counteract a force of the spring 312) may occur from particles (e.g., sand particles or other contaminants), blockages, corrosion and/or fluid characteristics or conditions, for example. Additionally, higher flow rates through the low flow rate portion 208 may damage the low flow rate meter 209.

Turning to the example operating scenario of FIG. 4B, a low flow rate flow 408 moves through the compound utility meter 102 and the pressure member 308 is, in contrast to the example scenario of FIG. 4A, stuck in an open position, which may result from the spring 312 being prevented from moving and/or being damaged. As a result, the flow 408 with relatively low flow rates and/or pressure may still flow through the low flow meter 209 while flowing between the inlet 202 and the outlet 204. In this example, the flow 408 also flows through the high flow rate portion 206 and the high flow rate meter 207, which may not measure and/or may incorrectly measure the low flow rates therethrough, thereby creating erroneous and/or no flow rate measurements (e.g., the high flow rate meter 207 may not register any of the low flow rates), which may result in potential billing error(s) and/or lost revenue, for example.

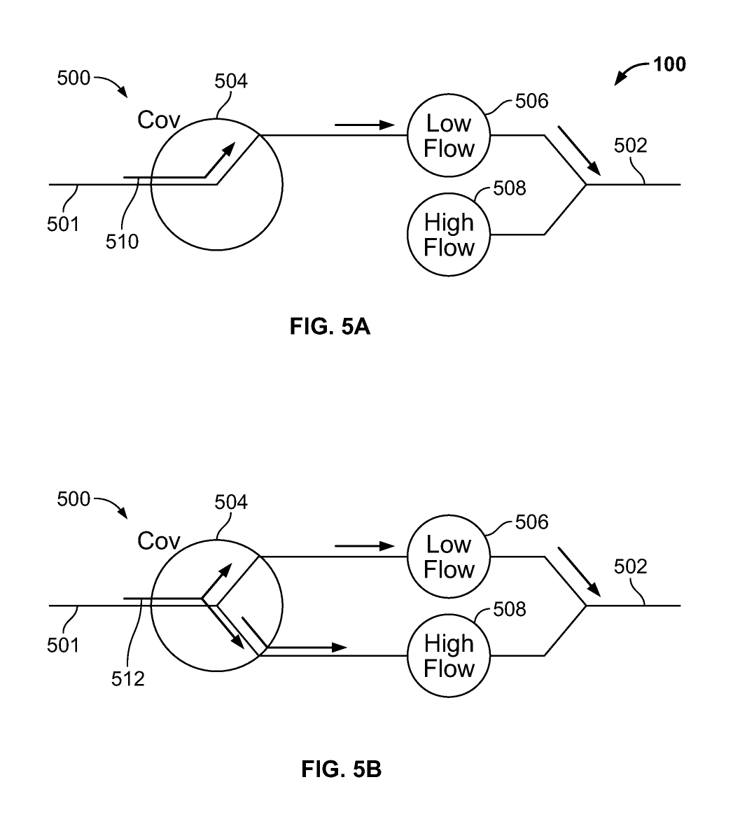

FIGS. 5A and 5B illustrate operating scenarios of another example utility meter 500 with a commutation valve system, which may also malfunction in a similar manner to the example scenario described above in connection with FIGS. 4A and 4B to create erroneous fluid measurements or insufficient flow. Turning to FIG. 5A, the example utility meter 500 includes an inlet 501, an outlet 502, a commutation valve 504, a low flow rate meter 506 and a high flow rate meter 508. In this example scenario, a high flow rate flow (e.g., a flow rate higher than the operating range of the low flow rate meter 506) 510 flows between the inlet 501 and the outlet 502, and the commutation valve 504 has malfunctioned (e.g., sediment has prevented the commutation valve 504 from switching modes/positions) to keep the commutation valve 504 stuck in a low flow rate position, thereby causing lower-than-demand flow rates through the outlet 502 even when there is high demand and/or inaccurate measurements for flows beyond the operational range of the low flow rate meter 506.

FIG. 5B illustrates another example scenario of the utility meter 500 in which the commutation valve 504 is prevented from diverting a low flow rate flow 512 from the high flow rate meter 508. Similar to the example scenario described above in connection with FIG. 5B, in this example scenario, low flow rates may flow from the inlet 501 to the outlet 502 via both the low flow rate meter 506 and the high flow rate meter 508, which may inaccurately measure and/or not measure a rate of flow therethrough.

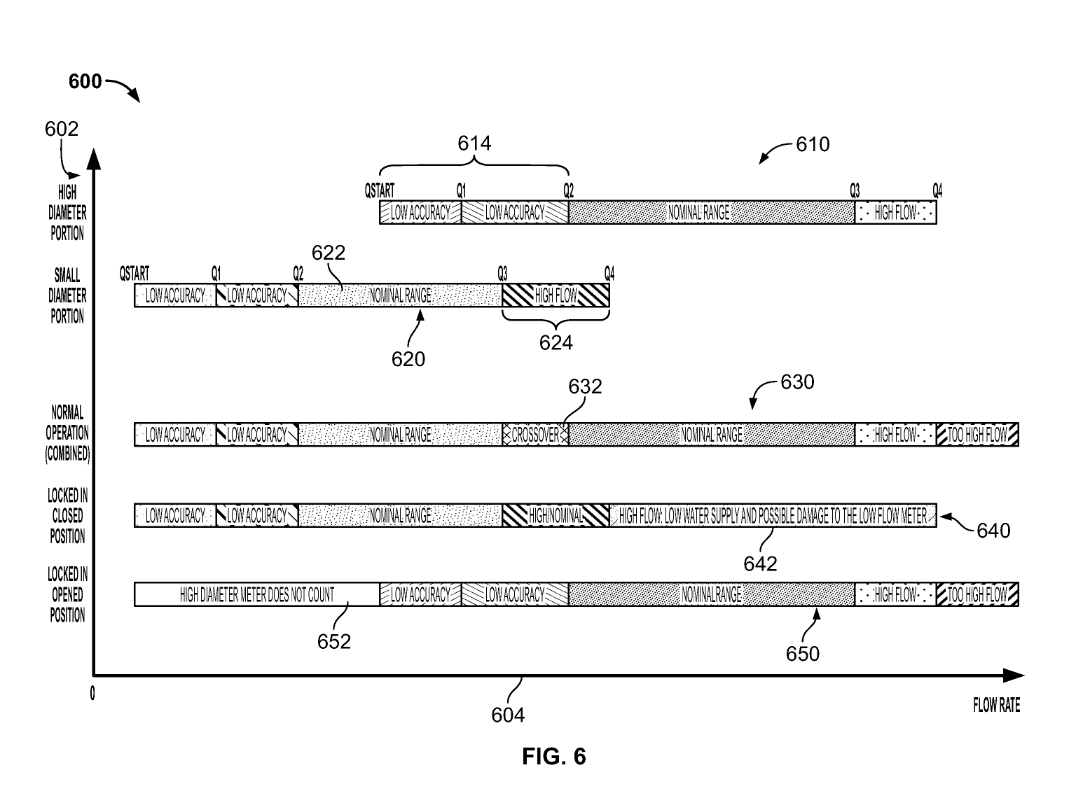

FIG. 6 is an example flow meter graph 600 that illustrates example flow meter operations and use of the examples disclosed herein. In particular, the flow meter graph 600 illustrates a manner in which compound utility meters may be monitored via a data analyzer such as the data analyzer 104 described above in connection with FIG. 1. In particular, data from a low flow rate meter and a high flow rate meter of a compound utility meter such as the compound utility meter 102 or the compound utility meter 108 of FIG. 1 is analyzed as a single virtual meter, for example, in which data received from low flow and high flow branches and/or associated time histories of flow related to the low flow and high flow branches is analyzed to determine a failure condition (e.g., an operating condition) of a compound utility meter.

The example flow meter graph 600 illustrates this analysis and includes a vertical axis 602, which represents different characteristic portions of the compound utility meter and scenarios of the compound utility meter taken as a combination of multiple flow rate meters (e.g., first and second flow rate meters, high and low diameter portions, etc.). A horizontal axis 604 of the illustrated example represents the flow rate through the compound utility meter. A first bar graph 610 of the illustrated example represents a detection range of a high flow rate meter (e.g., a high diameter portion) defined by segments separated by points labeled as “Qstart,” “Q1,” “Q2,” “Q3” and “Q4.” The segments separated by Q1-Q4 depict different accuracy ranges for the high flow rate meter. The segments denoted as “Nominal Range” and “High flow” are ranges in which the high flow rate meter may measure flow rates with accuracy and/or within certain pre-defined error percentages (approximately 3-8%). A portion 614 denotes a range in which the high flow rate meter may not properly measure flow rates and/or a threshold range that may be used to indicate failure of the compound utility meter (e.g., low rate flows are flowing through the high flow rate meter and, thus a bypass mechanism of the compound utility meter is not properly operating). As can be seen by the bar graph 610, at lower flow rates, the high flow rate meter simply does not register any flow rate.

A second bar graph 620 of the illustrated example represents a detection range of a low flow rate meter, which has a significantly different operational range in comparison to the high flow rate meter represented by the first bar graph 610. The second bar graph 620 includes a nominal range 622 that overlaps the portion 614. The second bar graph 620 also includes a high flow portion 624, in which the low flow rate meter may not properly measure flow rates. Thus, a data analyzer may use the high flow portion 624 as a range to define a threshold (e.g., a threshold point, a threshold range to define a threshold point, a threshold range) to determine a failure of the compound utility meter (e.g., too high of a flow is passing through the low flow rate meter and, thus, a bypass mechanism of the compound utility meter is not properly operating). At higher flow rates beyond the point denoted by “Q4,” the low flow rate meter may sustain damage.

An example third bar graph 630 of the illustrated example illustrates combined operation (e.g., as a single virtual meter) of the high and low flow rate branches of the compound utility meter. As can be seen in this portion of FIG. 6, a crossover region 632 is located between nominal ranges of both the high and low flow rate meters. In this example, the crossover region 632 defines a range in which threshold alarms for both the high and low flow rate meters may be set. Setting the alarm threshold values in this region enables effective detection of failure of a bypass mechanism while allowing reasonably accurate measurements around the crossover region 632 when the compound utility meter is operating normally. In some examples, the threshold alarms for the high and low flow rate meters are set at identical values to one another.

An example fourth bar 640 graph illustrates operation of the compound utility meter when the bypass mechanism has failed into a closed position (e.g., the example scenarios of FIGS. 4A and 5A). Because higher rate flows are not passing through the high flow rate portion, a high flow region 642 for the low flow rate meter is defined in which water supply is limited and/or the low flow rate meter may be damaged. Thus, the low flow rate portion threshold may be at a lower flow rate and/or flow rate range than the high flow region 642.

An example fifth bar graph 650 illustrates operation of the compound utility meter when the bypass mechanism has failed into an open position (e.g., the example scenarios of FIGS. 4B and 5B). The example bar 650 defines a region 652, in which the high flow rate meter does not measure any flow rate (e.g., an impeller is not moved by slow flowing fluid). Thus, the low accuracy segments adjacent the nominal range of the fifth bar graph 650 define a range for which a high flow rate portion threshold may be established.

Based on the example graph 600 above, monitoring and/or analyzing multiple flow rate regimes via multiple flow rate sensors allows a data analyzer such as the data analyzer 104, for example, to verify operation of the compound utility meter and/or that both flow rate portions are operating normally. Such monitoring of the operation of the flow rate portions allows compound utility meters to be replaced and/or serviced when they have a specific problem instead of being regularly replaced at scheduled intervals whether or not they are operating properly, which may result in premature and/or unnecessary replacement of the compound utility meters and the associated costs with such scheduled replacements.

To analyze a failure condition (e.g., operating condition) of the compound utility meter, the data analyzer (e.g., the data analyzer 104) may determine, for example, that a high flow rate branch has measured flow rates corresponding to the low flow rate branch and, thus, determine that the compound utility meter has failed and/or generate an alert. In some examples, a significant time duration (e.g., hours, days, weeks, etc.) of the out-of range flow may be taken into account. Likewise, the data analyzer may determine, for example, that a low flow rate branch of a compound utility meter has measured flow rates corresponding to the high flow rate branch and, thus, determine that the compound utility meter has failed and/or generate an alert. Alternatively, the low flow rate branch may also take a time duration into account. In other words, in some examples, if any flow rate branches measure a flow rate value that is out of its respective threshold for that specific flow rate branch, the data analyzer may determine a failure of the compound utility meter and/or generate an alert. In other examples, only a behavior (e.g., a characteristic curve or deviation from a characteristic curve) of the high flow rate branch is used to determine a failure (e.g., how the high flow rate branch transitions to high flow rate flow in terms of slope and/or a characteristic curve(s), whether the high flow rate branch measures low flow rate flow, etc.).

Additionally or alternatively, in some examples, when the high flow rate branch or the low flow rate branch has not measured flow (e.g., has not measured a significant amount of flow) over a specified time duration (e.g., a week, a day, etc.), an alert may be generated because it may be likely that the compound utility meter has malfunctioned (e.g., the compound utility meter is determined to be stuck in a low flow position for several days because measurements have not been received from the high flow rate meter for several days). In some examples, differentials (e.g., differentials simultaneously determined and/differential time history between the high flow rate branch and the low flow rate branch) between a high flow rate branch and a low flow rate branch are analyzed to determine a failure condition.

In some examples, the compound utility meter is monitored for a specified duration of time (e.g., a week, days, an hour, etc.) to ensure that lapses in data received from a particular flow rate portion occur over a significant time and/or infrequent or rare out-of-range readings are not used in the determination of an operating status (e.g., a functional state) of the compound utility meter when it is, in fact, operating normally (e.g., during normal operation). In particular, there may be some outlier points (e.g., random error, infrequent error(s), etc.) that are out of threshold ranges, but do not necessarily indicate malfunction of the utility compound meter.

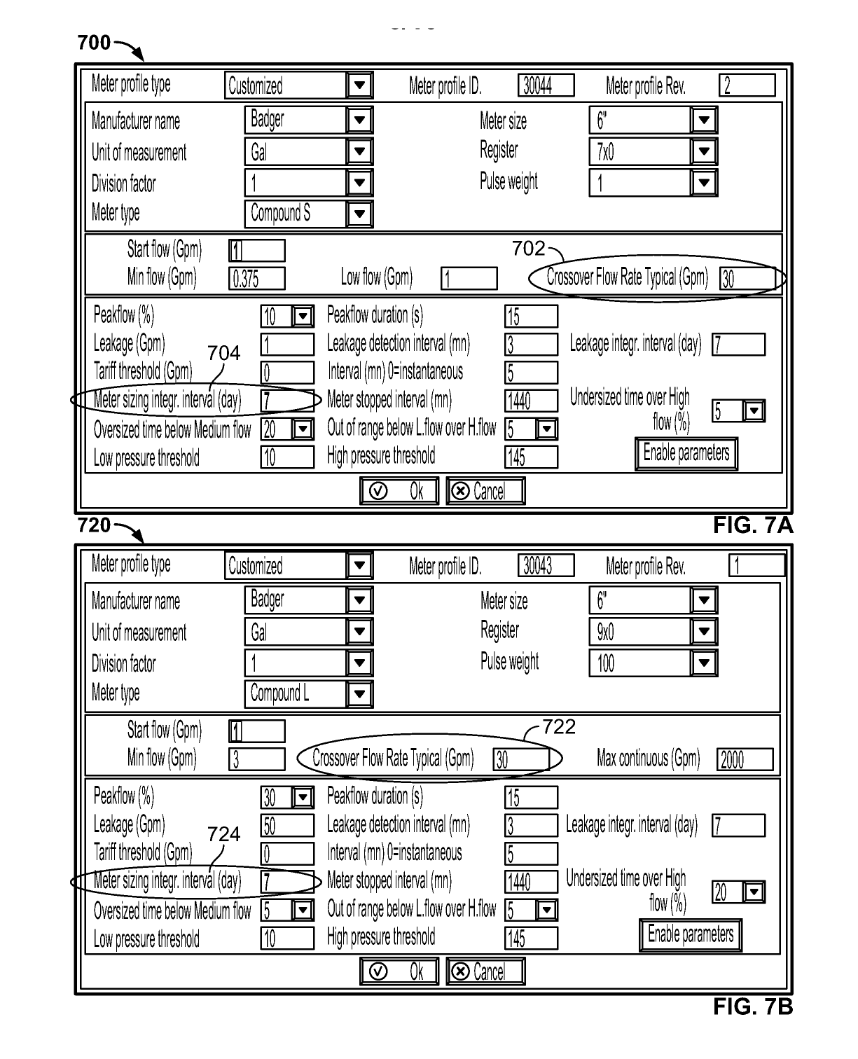

FIG. 7A is a screenshot of an example low flow rate meter interface (e.g., an input interface) 700 displayed on a terminal such as the terminal 116 of FIG. 1. In this example, the terminal 116 may receive input utility meter variables to analyze and/or generate alarms of a compound utility meter from a data analyzer such as the data analyzer 104 of FIG. 1. For example, a user may input a low flow rate branch alarm threshold 702 to define a flow rate and/or flow rate range in which the data analyzer determines a failure of the compound utility meter based on flow data for the low flow rate branch, for example. In some examples, the alarm threshold 702 is used to define a threshold in which the low flow rate meter may exceed for a defined duration of time to trigger an alert. In this example, the user may also input a monitoring interval (e.g., an integration interval, a data time-averaging interval, etc.) 704 to define a time period (e.g., a day, a week, several weeks, etc.) in which data regarding the utility compound meter is analyzed and/or averaged to determine a failure condition while potentially dismissing outlying or anomalous data points, for example.

FIG. 7B is a screen shot of an example high flow rate interface (e.g., an input interface) 720 that may be accessed by a user of the terminal 116, for example. Similar to the low flow rate interface 700 described above in connection with FIG. 7A, the high flow rate interface 720 includes a high flow rate branch alarm threshold 722 that is provided by the user to define a transition value and/or threshold in which a data analyzer and/or a terminal receiving data from the data analyzer defines a respective failure threshold of the compound utility meter based on flow data for the high flow rate branch, for example. In some examples, the alarm threshold 722 is used to define a threshold in which the high flow rate meter may exceed for a defined duration of time to trigger an alert. The high flow rate interface 720 also includes a monitoring interval 724 to be provided by the user to define a time duration in which flow data is analyzed.

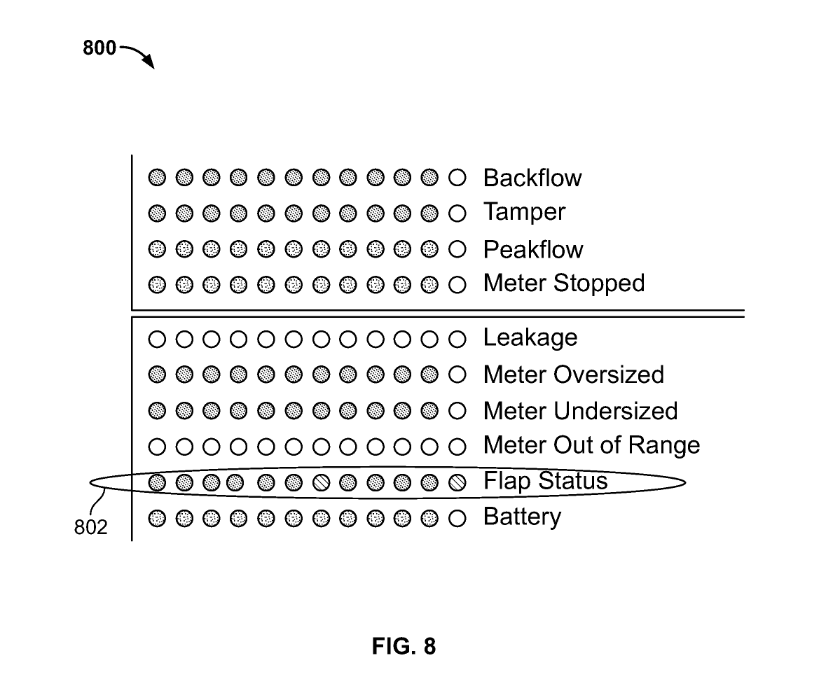

FIG. 8 depicts an example output display 800 that may be used to indicate flap status (e.g., whether failure(s) have occurred) of a single compound utility meter based on the examples disclosed herein. The example output display 800 may be shown on a terminal such as the terminal 116 of FIG. 1 and includes a valve status indicator 802. In some examples, the valve status indicator 802 simultaneously displays numerous valve (e.g., commutation valves, bypass valves, etc.) status updates on the output display 800.

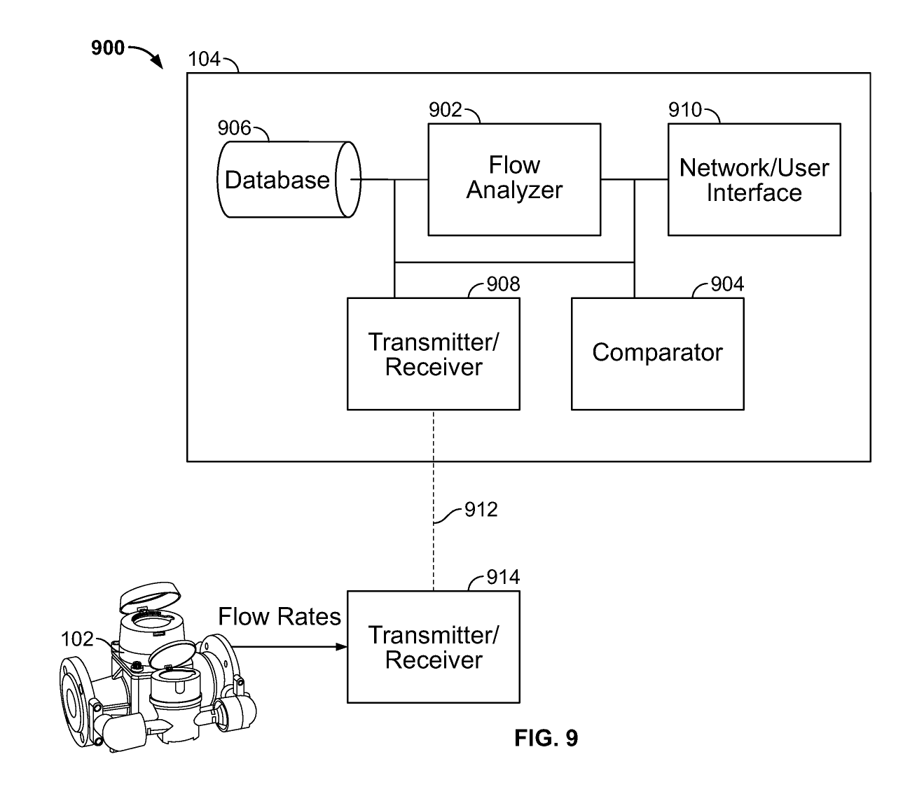

FIG. 9 is an example flow analysis system 900 that may be used to implement the examples disclosed herein. In this example, the system 900 includes the example data analyzer 104, which includes an example flow analyzer 902, a comparator 904, a database 906, a transmitter/receiver 908 and a network/user interface 910. In other examples, the example system 900 may be implemented on a terminal such as the terminal 116 of FIG. 1, for example. In this example, a communication interface 912 communicatively couples a transmitter/receiver 914 to the transmitter/receiver 908 of the data analyzer 104. The transmitter/receiver 914 of the illustrated example is communicatively coupled to the compound utility meter 102 and/or the individual flow meters 207, 209 of the compound utility meter 102.

In operation, the compound utility meter 102 measures (e.g., periodically measures, measures when polled, etc.) flow rates at both the high flow rate meter 207 and the low flow rate meter 209 of the compound utility meter 102 and/or an amount of time the flow rate meters 207, 209 measure data during a defined time period (e.g., out-of-threshold data over a specified time duration, etc.), for example. Additionally or alternatively, an amount of total flow through either of the flow meters 207, 209 may be taken into account. The transmitter/receiver 914 of the illustrated example, which may be integral with the compound utility meter 102, receives flow rate data from both the high and low flow rate meters 207, 209, respectively, and transmits the flow rate data (e.g., time averaged flow rate data, flow rate history measurements, etc.) to the transmitter/receiver 908 via the communication interface 912, which may be wireless or wired communications. In this example, the flow analyzer 902 may receive this flow rate data from the transmitter/receiver 908 and access and/or index threshold data (e.g., high and low flow rate thresholds for the high and low flow rate meters, respectively) from the database 906 to verify that the compound utility meter 102 is operating within normal parameters.

In this example, the flow analyzer 902 and/or the comparator 904 compares the flow rate data (e.g., flow rate values, time-averaged flow rate data, flow rate ranges measured over time) to the respective threshold data (e.g., high flow rate branch data, low flow rate branch data) and/or analyzes patterns of flow data during a defined period to verify that the utility compound meter 102 is operating normally. In some examples, the comparator 904 compares and/or analyzes whether both the high and low flow rate meters 207, 209, respectively, have measured above or below a threshold flow (e.g., during a specified time period) and/or an amount of time spent at different flow rates for the high and low flow rate meters 207, 209. In this example, if the flow analyzer 902 determines that the utility compound meter is not operating within normal parameters, the flow analyzer 902 causes the network/user interface 910 to send an alarm and/or triggers an alert via a network such as the telecommunications network 114 of FIG. 1.

In some examples, this alarm is sent to a portable device such as the portable device 118 as an SMS message via the network user interface 910, for example. This alarm transmission may be used to alert service staff that the compound utility meter is improperly operating and that a replacement, service and/or repair may be necessary. In some examples, a terminal such as the terminal 116 performs this monitoring of the utility compound meter 102. Alternatively, in some examples, the data analyzer 104 is integral with the compound utility meter 102.

While an example manner of implementing the utility meter monitoring system 100 of FIG. 1 is illustrated in FIG. 9, one or more of the elements, processes and/or devices illustrated in FIG. 9 may be combined, divided, re-arranged, omitted, eliminated and/or implemented in any other way. Further, the example data analyzer 104, the example flow analyzer 902, the example comparator 904, the example transmitter/receiver 908, the example network/user interface 910, the communication interface 912, the transmitter/receiver 914, the compound utility meter 102 and/or, more generally, the example flow analysis system 900 of FIG. 9 may be implemented by hardware, software, firmware and/or any combination of hardware, software and/or firmware. Thus, for example, any of the example data analyzer 104, the example flow analyzer 902, the example comparator 904, the example transmitter/receiver 908, the example network/user interface 910, the communication interface 912, the transmitter/receiver 914, the compound utility meter 102 and/or, more generally, the example flow analysis system 900 of FIG. 9 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this disclosure to cover a purely software and/or firmware implementation, at least one of the example data analyzer 104, the example flow analyzer 902, the example comparator 904, the example transmitter/receiver 908, the example network/user interface 910, the communication interface 912, the transmitter/receiver 914, and/or the compound utility meter 102 is/are hereby expressly defined to include a tangible computer readable storage device or storage disk such as a memory, a digital versatile disk (DVD), a compact disk (CD), a Blu-ray disk, etc. storing the software and/or firmware. Further still, the example utility meter monitoring system 100 of FIG. 1 may include one or more elements, processes and/or devices in addition to, or instead of, those illustrated in FIG. 9, and/or may include more than one of any or all of the illustrated elements, processes and devices.

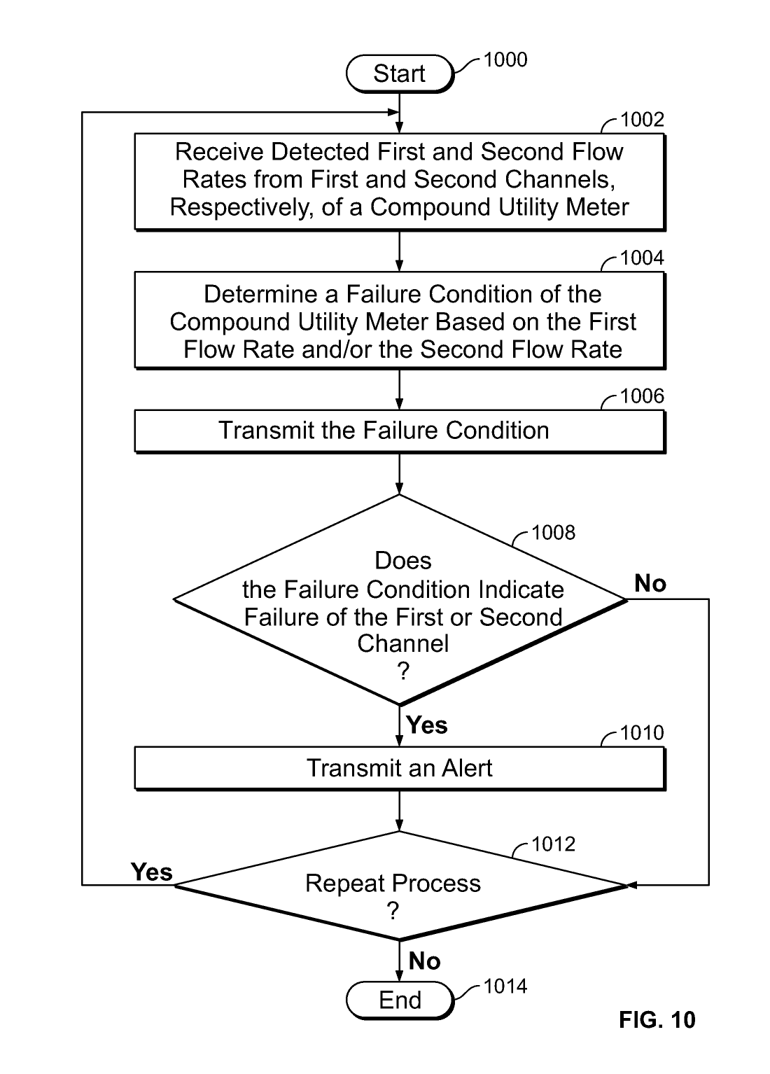

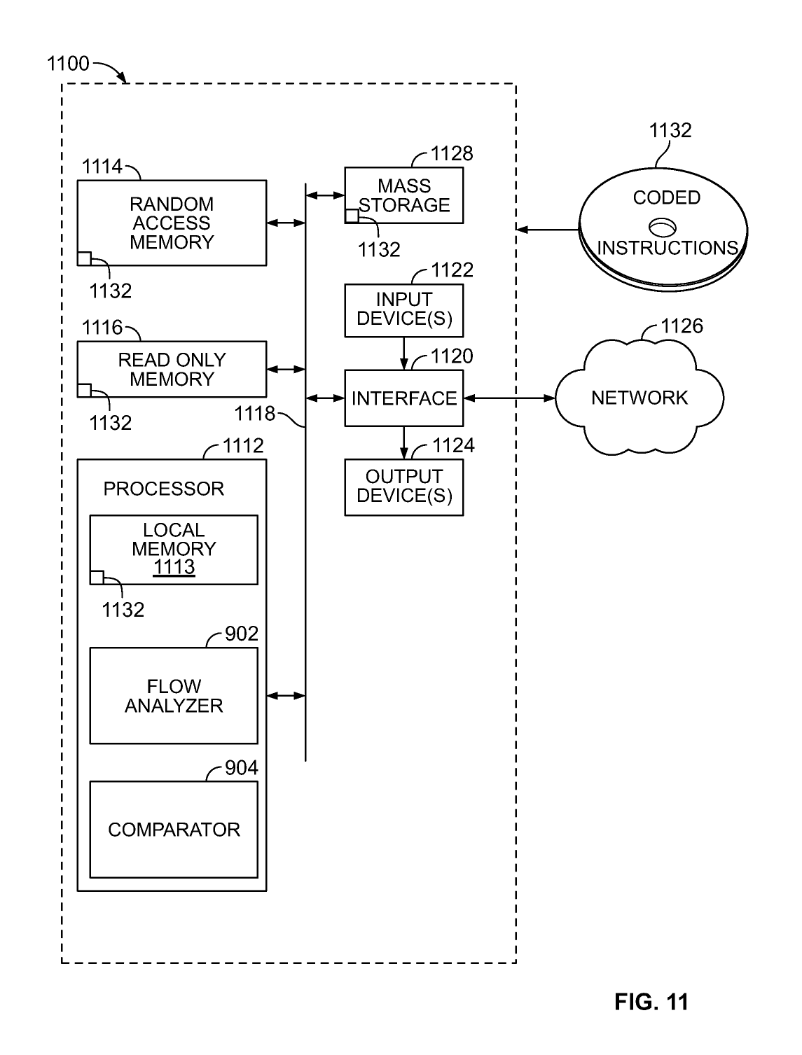

A flowchart representative of example machine readable instructions for implementing the flow analysis system 900 of FIG. 9 is shown in FIG. 10. In this example, the machine readable instructions comprise a program for execution by a processor such as the processor 1112 shown in the example processor platform 1100 discussed below in connection with FIG. 11. The program may be embodied in software stored on a tangible computer readable storage medium such as a CD-ROM, a floppy disk, a hard drive, a digital versatile disk (DVD), a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowchart illustrated in FIG. 10, many other methods of implementing the example flow analysis system 900 may alternatively be used. For example, the order of execution of the blocks may be changed, and/or some of the blocks described may be changed, eliminated, or combined.

As mentioned above, the example process of FIG. 10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example process of FIG. 10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The flow chart of FIG. 10 is representative of an example process that may be used to implement the examples disclosed herein. The example process begins at block 1000 where an installed compound utility meter such as the compound utility meter 102 is being monitored to indicate potential malfunctions and/or incorrect operation. A data analyzer (e.g., the data analyzer 104) receives a detected first flow rate from a high flow rate meter (e.g., the high flow rate meter 207) of a first channel (e.g., a high flow rate branch) of the compound utility meter and a second flow rate detected at a low flow rate meter (e.g., the low flow rate meter 209) of a second channel (e.g., a low flow rate branch) of the compound utility meter (block 1002).

A failure condition (e.g., an operational/failure status) of the compound utility meter is determined based on the first and/or second flow rates (e.g., whether the first and second flow rates are beyond their respective thresholds) and/or a time-history of the first and second flow rates (e.g., whether the first or second flow rates are out of respective thresholds for a time duration greater than a specified time) by a flow analyzer such as the flow rate analyzer 902 and/or a comparator such as the comparator 904, for example (block 1004). In some examples this determination is based on comparing threshold values accessed/indexed from a database such as the database 906 to measured flow rates and/or flow rate histories, for example.

In some examples, the data analyzer of the illustrated example transmits the determined failure condition (block 1006). For example, the failure condition is transmitted so that a terminal (e.g., the terminal 116) and/or a portable device (e.g., the portable device 118) can utilize the failure condition and/or query the data analyzer for flow rate information to determine if the utility compound meter is operating within normal parameters. In some examples, the failure condition is transmitted only when a threshold has been exceeded for a predefined time duration.

Next, it is determined if the failure condition indicates that the first or second channel has a failure (e.g., alarms, one or more flow rates out of threshold ranges, etc.) (block 1008). Such a determination may be made by a flow analyzer (e.g., the flow analyzer 902) and/or a comparator (e.g., the comparator 904). In some examples, if the compound utility meter is not operating within expected parameters (block 1008), a network interface such as the network interface 910 is used to transmit an alert and/or alert service personnel that the utility compound meter needs to be replaced, for example (block 1010). Otherwise, if the failure condition is not outside of the acceptable criteria (block 1008), an alert is not transmitted.

Regardless of whether the failure condition is outside the acceptable criteria, it is then determined whether the process is to be repeated (block 1012). If the process is to be repeated (block 1012), the process repeats (block 1002). If the process is not to be repeated (block 1012), the process ends (block 1014).

FIG. 11 is a block diagram of an example processor platform 1100 capable of executing the instructions of FIG. 10 to implement the flow analysis system 900 of FIG. 9. The processor platform 1100 can be, for example, a server, a personal computer, a mobile device (e.g., a cell phone, a smart phone, a tablet such as an iPad™), a personal digital assistant (PDA), an Internet appliance, a digital video recorder, a personal video recorder, a set top box, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache). The processor 1112 of the illustrated example also includes the flow analyzer 902 and the comparator 904. The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIG. 10 may be stored in the mass storage device 1128, in the volatile memory 1114, in the non-volatile memory 1116, and/or on a removable tangible computer readable storage medium such as a CD or DVD.

From the foregoing, it will be appreciated that the above disclosed methods and apparatus allow efficient and quick determinations of failure conditions of compound utility meters. The examples disclosed herein allow more cost effective operations by avoiding scheduled replacements of compound utility meters, which are typical and often occur when the compound utility meter is still operating correctly. The examples disclosed herein allow compound utility meters to be replaced when they malfunction and, thus, avoiding costs associated with premature/scheduled replacement of the compound utility meters.

Although certain example methods, apparatus and articles of manufacture have been disclosed herein, the scope of coverage of this disclosure is not limited thereto. On the contrary, this disclosure covers all methods, apparatus and articles of manufacture fairly falling within the scope of the claims of this disclosure. While the examples disclosed herein are shown related to compound utility meters, they may be applied to any appropriate compound meter.

What is claimed is:

1. An apparatus comprising:
a receiver to receive fluid flow rate data from a first fluid flow rate meter on a first channel of a compound utility meter and a second fluid flow rate meter on a second channel of the compound utility meter; and
a processor communicatively coupled to the receiver, wherein the processor is to determine a failure condition of the compound utility meter based on the flow rate data received from the first and second fluid flow rate meters.

2. The apparatus as defined in claim 1, further including a network interface to transmit an alert when the failure condition is out of an acceptable range.

3. The apparatus as defined in claim 2, wherein the alert transmitted as an SMS message.

4. The apparatus as defined in claim 1, wherein the processor is integral with the compound utility meter.

5. The apparatus as defined in claim 1, wherein the failure condition is determined based on whether the flow rate data indicates one or more of that a first flow rate of the first channel has exceeded a first threshold or that a second flow rate of the second channel is below a second threshold.

6. The apparatus as defined in claim 1, wherein the failure condition is based on an amount of flow through the first or second channels over a time duration.

7. The apparatus as defined in claim 1, wherein the flow rate data includes indications of whether the first or second flow rate meters have made measurements out of their respective threshold ranges over a defined time duration.

8. The apparatus as defined in claim 1, wherein the compound utility meter includes a bypass valve.

9. The apparatus as defined in claim 1, wherein the processor is located in a data analyzer.

10. A method comprising:
receiving first flow rate data from a first fluid flow rate meter that is on a first channel of a compound utility meter;
receiving second flow rate data from a second fluid flow rate meter that is on a second channel of the compound utility meter; and
determining, via a processor, a failure condition of the compound utility meter based on the first and second flow rate data.

11. The method as defined in claim 10, wherein determining the failure condition of the compound utility meter is based on whether the first flow rate data indicates that a first flow rate of the first channel has exceeded a first threshold, or that a second flow rate of a the second channel is below a second threshold.

12. The method as defined in claim 10, further including transmitting the failure condition to a data collection network.

13. The method as defined in claim 10, further including transmitting an alert when the failure condition of the compound utility meter indicates a failure of the compound utility meter.

14. A tangible machine readable medium having instructions stored thereon, which when executed, cause a machine to:
receive flow rate data from a plurality of flow meters of a compound utility meter; and
determine a failure condition of the compound utility meter based on the flow rate data.

15. The machine readable medium as defined in claim 14, which when executed, further cause a machine to transmit an alert when the failure condition indicates a failure of the compound utility meter.

16. The machine readable medium as defined in claim 14, wherein the failure condition is determined based on whether the flow rate data indicates that a flow meter of the plurality of flow meters has been out of a respective threshold range.

17. The machine readable medium as defined in claim 14, wherein the flow rate data includes time histories of the flow meters.

18. The machine readable medium as defined in claim 14, wherein the failure condition is determined based on whether any of the flow meters are beyond a respective threshold for a specified time duration.
